(19) United States
(12) Patent Application Publication
(10) Pub. No.: US 2025/0083841 A1
(43) Pub. Date: Mar. 13, 2025

(54) DRONE INTEGRATION WITH VEHICLE

(71) Applicant: Polaris Industries Inc., Medina, MN (US)

(72) Inventors: Owen A. Dickinson, Wyoming, MN (US); Joshua DeSmet, Wyoming, MN (US)

(73) Assignee: Polaris Industries Inc., Medina, MN (US)

(21) Appl. No.: 18/829,576

(22) Filed: Sep. 10, 2024

Related U.S. Application Data
(60) Provisional application No. 63/537,618, filed on Sep. 11, 2023.

(51) Int. Cl. B64U 70/93; B64U 20/80; B64U 50/37; B64U 60/50

(52) U.S. Cl. CPC B64U 70/93; B64U 20/80; B64U 50/37; B64U 60/50

(57) ABSTRACT

A vehicle, system, and method for drone integration with a vehicle is provided. The vehicle may comprise a plurality of ground engaging members, a frame assembly supported by the plurality of ground engaging members, a powertrain operatively coupled to at least one of the plurality of ground engaging members, a docking station supported the frame assembly and a drone releasably coupled to the docking station in a home position, the docking station configured to secure the drone thereto and charge the drone when in the home position, wherein the vehicle is in communication with the drone such that the drone selectively lands on the docking station.

### CROSS-REFERENCE TO RELATED APPLICATION

The present application claims priority to U.S. Provisional Patent Application No. 63/537,618, filed Sep. 11, 2023, the entire disclosure of which is incorporated herein by reference.

### BACKGROUND

Recreational vehicles, such as all-terrain vehicles (ATVs), utility vehicles (UVs), snowmobiles, and side-by-side vehicles are widely used for recreational purposes. These vehicles might be used on roads, trails, dunes, or other types of terrain. Various systems have been developed to assist riders of recreational vehicles understand the various terrain, points of interest, and status of roads and trails.

### SUMMARY

As set forth above, embodiments provided herein relate to drone use with a recreational vehicle. Exemplary embodiments include, but are not limited to, the following.

In an exemplary embodiment of the present disclosure, a vehicle is provided. The vehicle may include a plurality of ground engaging members, a frame assembly supported by the plurality of ground engaging members, a powertrain operatively coupled to at least one of the plurality of ground engaging members, a docking station supported the frame assembly, and optionally a drone releasably coupled to the docking station in a home position. The docking station may be configured to secure the drone thereto and charge the drone when in the home position. The vehicle may also be in communication with the drone such that the drone selectively lands on the docking station.

In another exemplary embodiment thereof, a system is provided. The system may include a first vehicle, a group management master controller, and at least one drone. The first vehicle may include a plurality of ground engaging members, a frame assembly supported by the plurality of ground engaging members, a powertrain operatively coupled to at least one of the plurality of ground engaging members, a docking station supported by the frame assembly, and an operator panel including a display. The group management master controller may be operatively coupled to the display of the operator panel. The at least one drone may be operatively coupled to the group management master controller. The at least one drone may provide an indication of a position of the drone relative to the first vehicle to the group management master controller. The position of the drone may be displayed on the display of the operator panel. The at least one drone may be configured to selectively dock onto the docking station of the first vehicle.

In another exemplary embodiment thereof, a method of facilitating usage of a drone with a vehicle is provided. The vehicle may include a plurality of ground engaging members, a frame assembly supported by the plurality of ground engaging members, at least one controller supported by the frame wherein the drone is operatively coupled to the controller, and an operator panel supported by the frame. The method may include releasing the drone from a docking station, the docking station being supported by the frame of the vehicle and configured to charge the drone, instructing the drone to follow to a predetermined path, the predetermined path being at a predetermined distance relative to the vehicle, and receiving, via the controller, at least one of video or images from the drone, the at least one of video or images being displayed by the operator panel of the vehicle.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 illustrates a left front perspective view of an exemplary vehicle of the present disclosure with body panels removed to better illustrate the frame and other components;

FIG. 2 illustrates a left front perspective view of the vehicle of of FIG. 1 including the body panels;

FIG. 3 illustrates a left front perspective view of an exemplary drone of the present disclosure;

FIG. 4 illustrates a representative view of an exemplary vehicle and drone system of the present disclosure based on the vehicle and drone of FIGS. 1-3;

FIG. 5 illustrates an exemplary docking station supported by the vehicle of FIG. 2;

FIGS. 6A and 6B illustrate exemplary embodiments of a docking station of FIG. 5 and the drone of FIG. 3 engaged therewith;

FIGS. 7A and 7B illustrate the docking stations of FIGS. 6A and 6B with the respective docking station in a disengaged configuration;

FIG. 8 illustrates an embodiment of the drone of FIG. 3 following a predetermined path relative to the vehicle of FIG. 2;

FIG. 9A illustrates an embodiment of an exemplary operator panel display of the vehicle of FIG. 2;

FIG. 9B illustrates another embodiment of the operator panel display of FIG. 9A;

FIG. 10 illustrates an embodiment of a communication system between the vehicle of FIG. 5, the drone of FIG. 3, and an exemplary group management master controller;

FIGS. 11A-11B illustrates an exemplary embodiment of group management master controller of FIG. 10; and

FIGS. 12A and 12D illustrate various exemplary embodiments of boundaries of a user group.

Corresponding reference characters indicate corresponding parts throughout the several views. Although the drawings represent embodiments of the present disclosure, the drawings are not necessarily to scale, and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION OF THE DRAWINGS

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. Rather, the embodiments are chosen and described so that others skilled in the art may utilize their teachings. While the present disclosure is primarily directed to a utility vehicle, it should be understood that the features disclosed herein may have application to other types of vehicles such as other all-terrain vehicles, motorcycles, snowmobiles, and golf carts.

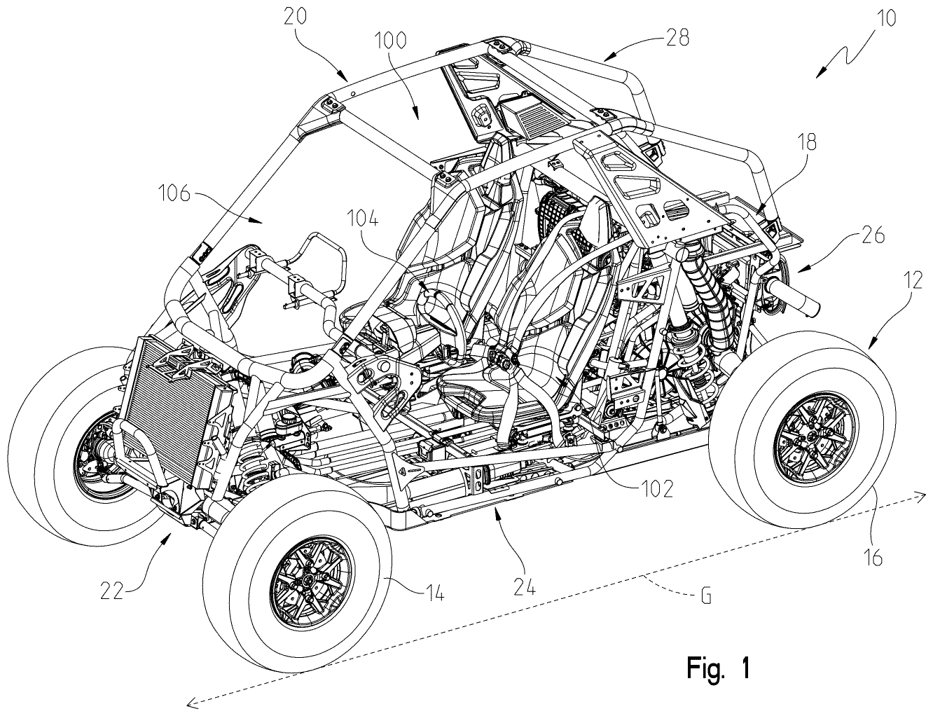

Referring to FIG. 1, an illustrative embodiment of an exemplary vehicle 10 is shown. Vehicle 10 is configured for off-road conditions. It should be appreciated that vehicle 10 is an exemplary recreational vehicle, particularly a side-by-side seating type recreational vehicle. Although exemplary vehicle 10 is shown, it should be appreciated that other side-by-side recreational vehicles may incorporate the teachings disclosed herein. In embodiments, vehicle 10 may include the systems and layout described in in U.S. patent application Ser. No. 16/523,471 (Attorney Docket PLR-04-28883.01P-US), the entire disclosure of which is incorporated by reference.

Vehicle 10 includes a plurality of ground engaging members 12, illustratively front wheels 14 and rear wheels 16. Exemplary ground engaging members include skis, endless tracks, wheels, and other suitable devices which support vehicle 10 relative to ground G. In one embodiment, one or more of the ground engaging members 12 may be include tracks, such as the Prospector II Tracks available from Polaris Industries Inc., located at 2100 Highway 55 in Medina, MN 55340 such as those shown in U.S. Pat. No. 7,673,711 (Attorney Docket PLR-01-177.02P-US) and U.S. Pat. No. 10,118,477 (Attorney Docket PLR-09-27412.02P-US) or non-pneumatic tires, such as those shown in U.S. Pat. No. 8,176,957 (Attorney Docket PLR-09-25371.01P) and U.S. Pat. No. 8,104,524 (Attorney Docket PLR-09-25369.01P).

Vehicle 10 includes open-air operator area 100 having seats 102. Seats 102 may include operator seat and passenger seat in a side-by-side relationship. Seats 102 are illustrated as side-by-side bucket seats but other exemplary seats such as a bench seat may be included. Further, in embodiments, vehicle 10 may be a crew style vehicle having a second row of seating behind seats 102 to provide additional seating options. The open-air operator area 100 further includes a steering input 104, illustratively a steering wheel is operatively coupled to front wheels 14 to alter a direction of travel of vehicle 10. The open-air operator area 100 may also include an operator panel 106. The operator panel 106 may be located opposite of seats 102 within the open-air operator area 100. In embodiments, operator panel 106 is part of a dash 107 of vehicle 10. In embodiments, operator panel 106 is supported by steering input 104 of vehicle 10.

Vehicle 10 further includes frame assembly 20 supported above ground G by the plurality of ground engaging members 12. Ground G may be generally level or undulating dirt, grass, concrete, or other surface. Frame assembly 20 may include cast portions, sheet metal portions, weldments, tubular components, or a combination thereof. Frame assembly 20 includes front frame assembly 22, middle frame assembly 24, and rear frame assembly 26. Middle frame assembly 24 is positioned between front frame assembly 22 and rear frame assembly 26 and is configured to support, among other components, seats 102 including seating for an operator and one or more passengers. Rear frame assembly 26 extends rearwardly from middle frame assembly 24 and may support cargo box 18. Front frame assembly 22 extends forwardly of middle frame assembly 24. In embodiments, an engine of vehicle 10 is positioned rearward of seats 102 and a seating surface of seats 102 is below an upper extent of the engine.

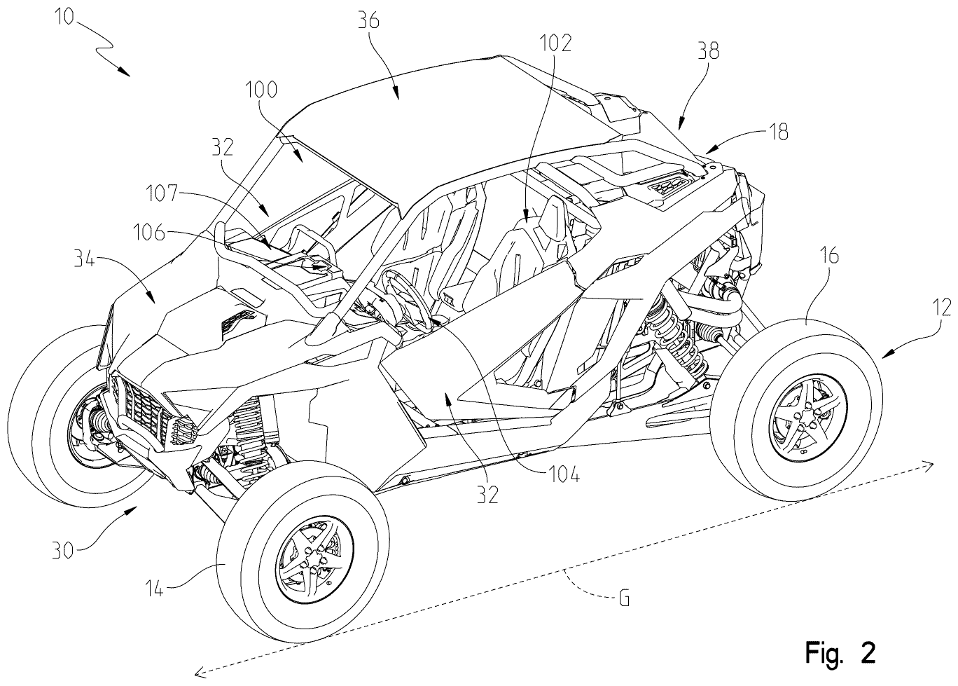

As shown in FIG. 2, vehicle 10 includes a plurality of body panels 30 supported by frame assembly 20. The plurality of body panels 30 may include operator and passenger side doors 32, hood 34, roof 36, and/or cargo box cover 38. Roof 36 may be removably coupled to an upper portion 38 of frame assembly 20 (e.g., as shown in FIG. 1). Cargo box 18 may be covered with removable cargo box cover 38 or may be left uncovered.

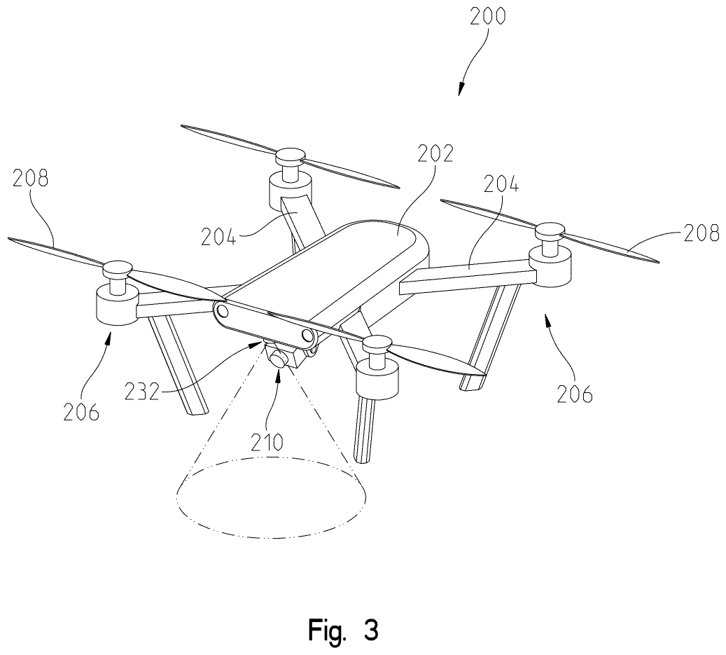

FIG. 3 is an illustrative embodiment of an exemplary drone 200. Drone 200 may be configured for use with vehicle 10. Drone 200 may be configured to communicate with vehicle 10 over a wireless network using various network protocols, such as Wi-Fi, cellular, a mesh network, and other suitable wireless protocols. Drone 200 includes body 202 and at least one arm 204 that extends outwardly from the body 202. Drone 200 includes propulsion system 206 which may include one or more propellers 208 that are coupled to the at least one arm 204. Drone 200 may also include a camera or video recorder 210 coupled to at least one of the body 202 or the at least one arm 204. Camera or video recorder 210 may be in communication with the vehicle 10, such as operator panel 106, via a wireless network. Drone 200 may also include a light 232 coupled to at least one of body 202 or at least one arm 204.

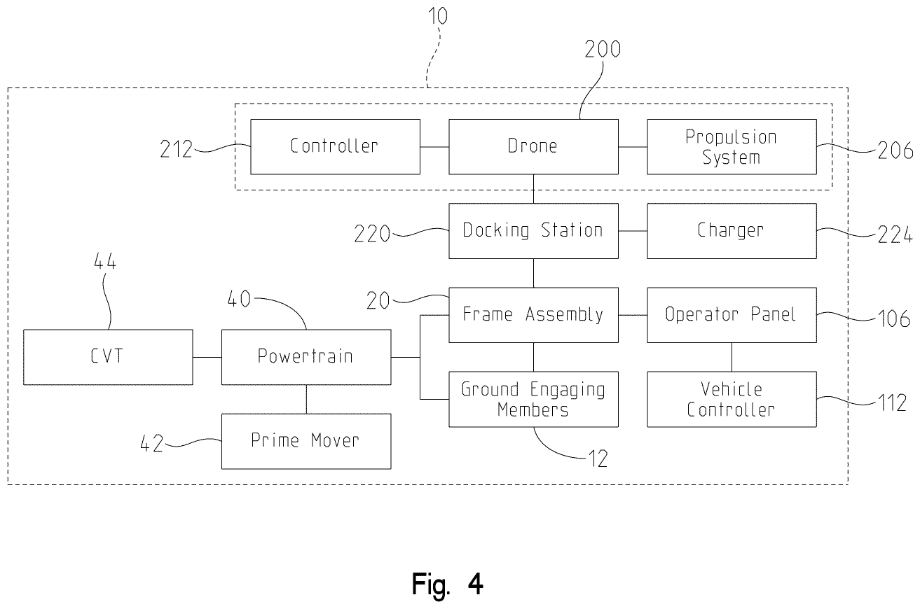

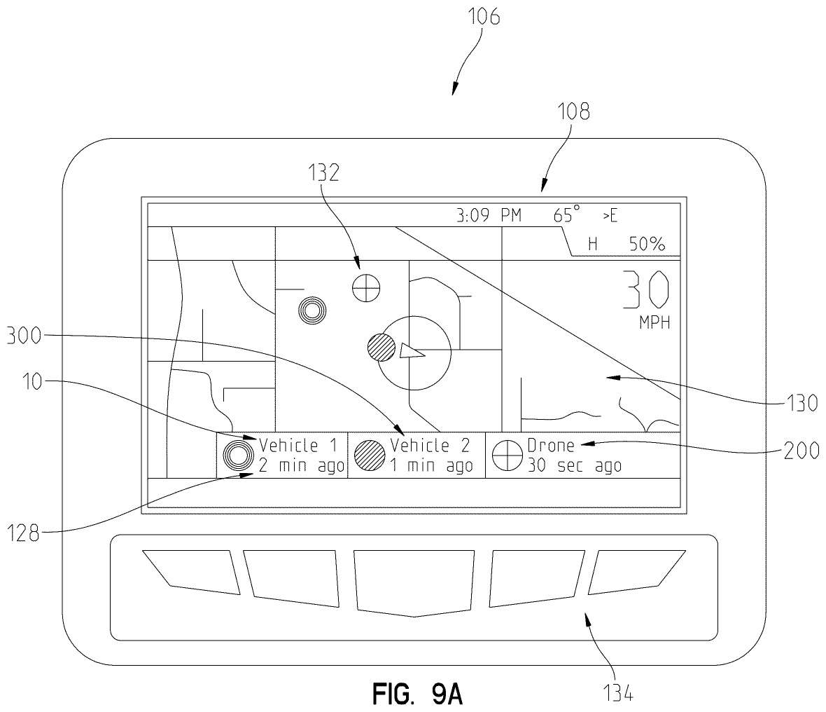

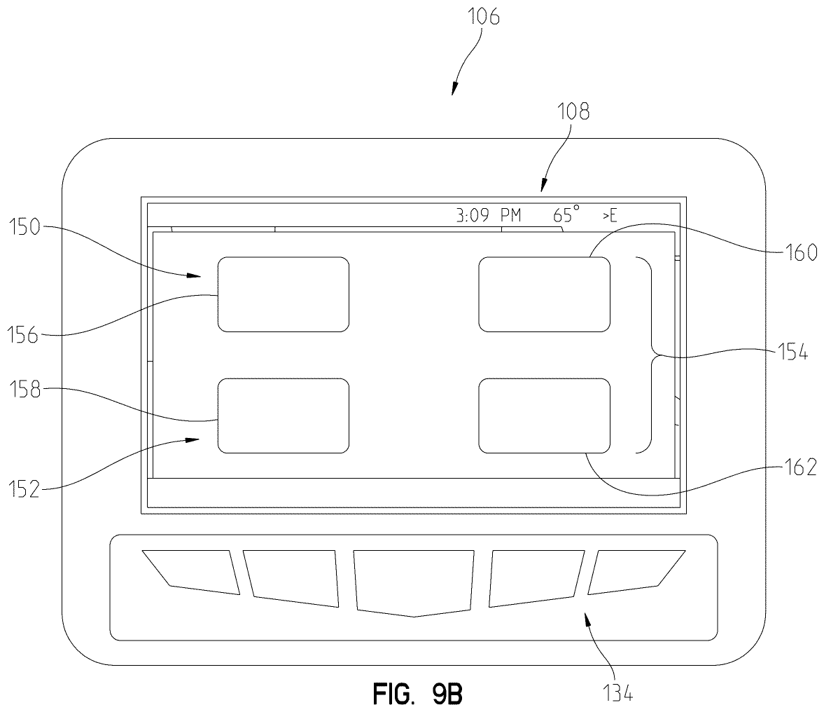

Referring to FIG. 4, various components of powertrain 40 are illustrated as supported by frame assembly 20 of vehicle 10. Powertrain 40 may be operatively coupled to at least one of the plurality of ground engaging members 12. Frame assembly 20 also supports powertrain 40 and its components which may include numerous high voltage carrying components including chargers, batteries, prime mover and/or drive train that provides power from the prime mover to at least one ground engaging member 14, 16. In some embodiments, components of powertrain 40, including the batteries, may be located underneath the open-air operator area 100. The powertrain 40 may include prime mover 42, which may include, but is not limited to, an electric motor, a combustion engine, or a hybrid system. Powertrain 40 may further include a transmission, which may be an automatic transmission or continuously variable transmission (CVT) 44. Frame assembly 20 may support operator panel 106. Operator panel 106 may be positioned within open-air operator area 100 (e.g., as shown in FIGS. 1-2). Operator panel 106 includes a display 108 (e.g., as shown in FIGS. 9A and 9B).

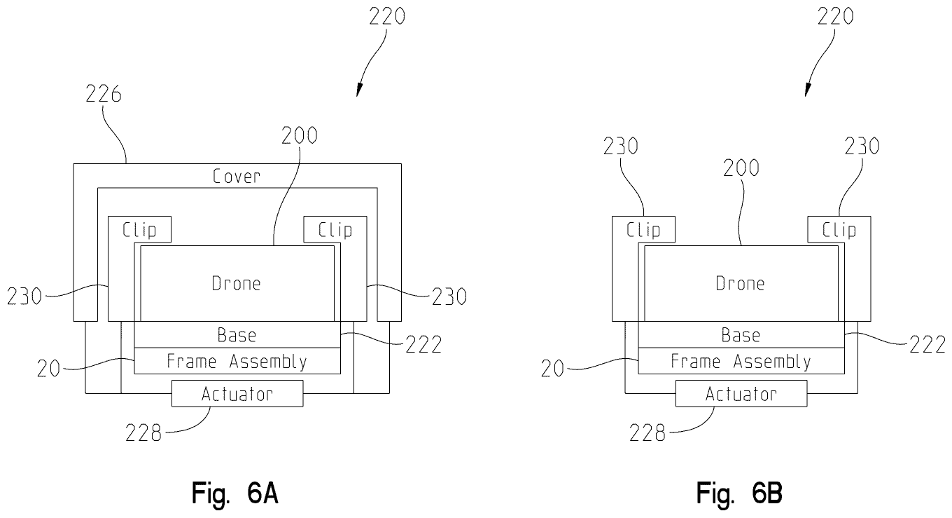

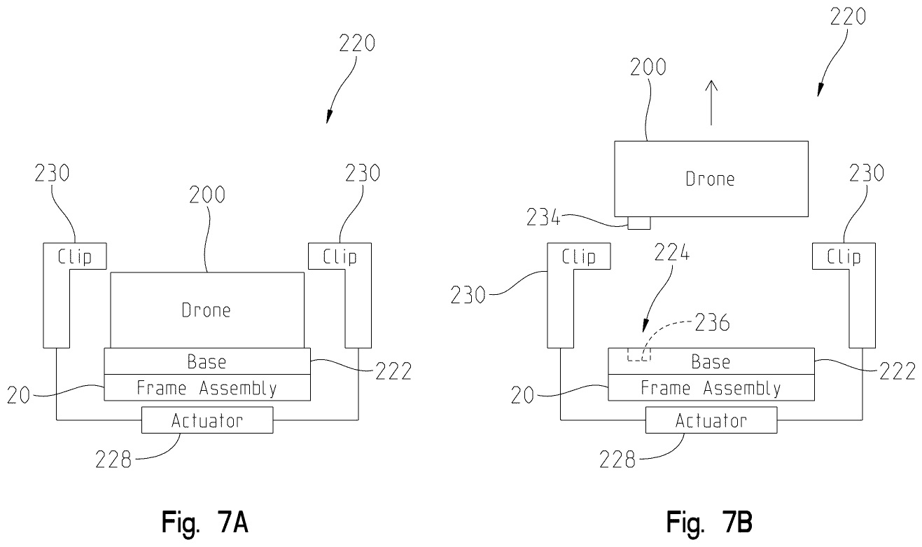

Further to FIG. 4, drone 200 may be supported by docking station 220 that is supported by frame assembly 20. Docking station 220 may be supported directly by the frame assembly 20 or may be supported by at least one body panel in the plurality of body panels 30, which are supported by frame assembly 20. Docking station 220 may further include charger 224 which may be integrated within docking station base 222. Charger 224 is configured to charge drone 200 when drone 200 is coupled to docking station 220. Docking station 220 is further described with respect to FIGS. 6A-7B. Vehicle 10 may be in communication with drone 200 such that drone 200 selectively lands on the docking station 220. Vehicle 10 and drone 200 may both include at least one controller 112, 212 to facilitate this communication. Controllers 112, 212 may each be single controllers or a plurality of distributed controllers operatively coupled together to perform the functionality disclosed herein. Communication may occur over any over a wireless network using various network protocols, such as Wi-Fi, cellular, a mesh network, and other suitable wireless protocols. Vehicle 10 may include controller 112 at any location, including by not limited to, at the operator panel 106. Controller 112 and/or operator panel 106 may be configured to receive information collected by drone 200, which may include information regarding location of either vehicle 10 or drone 200 or images/video collected by drone 220. Controller 212 associated with drone 200 may similarly be configured to received information collected by operator panel 106 and/or controller 112, which may include information regarding location of either vehicle 10 or drone 200. Further discussion on these concepts follows with respect to FIGS. 9-12.

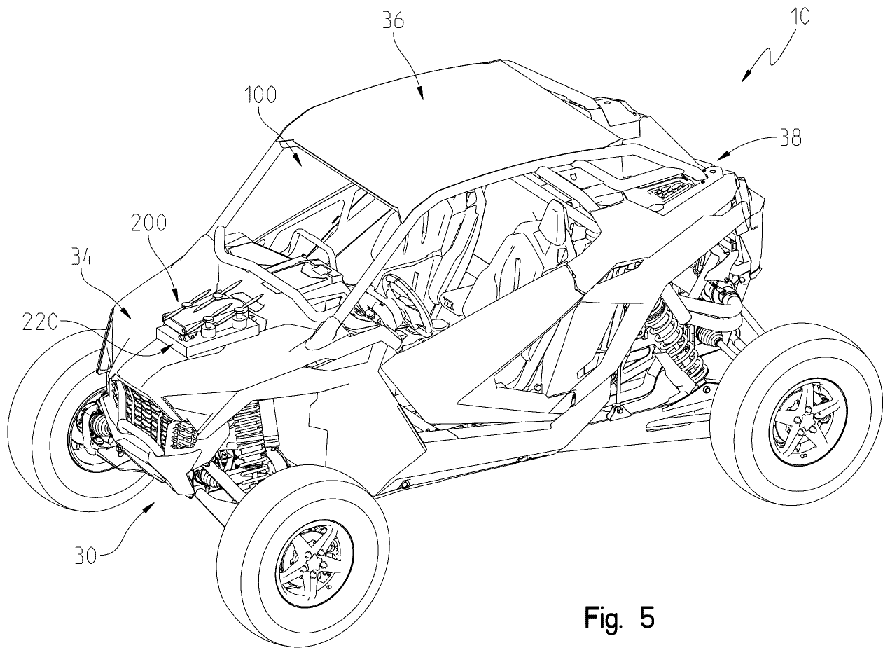

FIG. 5 is an illustrative embodiment of drone 200 positioned on docking station 220. FIG. 5 shows docking station 220 supported by hood 34 of vehicle 10 but docking station 220 may be positioned at any location about vehicle 10, including but not limited to, on the hood 34, the roof 36, or the cargo box cover 38. Docking station 220 may also be positioned within vehicle 10, such as within open-air operator area 100.

FIGS. 6A and 6B are illustrative embodiments of drone 200 engaged with docking station 220. Drone 200 is releasably coupled to docking station 220 in a home position. When in the home position, drone 200 is secured to and engaged with docking station 220. Drone 200 may be releasably coupled to docking station 220 in home position. Docking station 220 may include base 222, which is supported by the frame assembly 20 directly or by one of the body panels in the plurality of body panels 30 (e.g., any one of the hood 34, the roof 36, or the cargo box cover 38). In some embodiments, base 222 is integral with the frame assembly 20. In other embodiments, base 222 is permanently coupled to frame assembly 20 (e.g., welded). Base 222 may include charger 224, which is configured to charge drone 200 when drone 200 is in the home position on docking station 220. Exemplary charging systems include inductive charging.

In some embodiments, as shown in FIG. 6A, when drone 200 is in the home position, cover 226 may be positioned over drone 200 and docking station 220. The cover 226 is configured to protect drone 200 when drone 200 is not in use. Cover 226 may be manually removable by an operator or may be coupled to actuator 228 for automatic removal. FIG. 6B illustrates cover 226 removed from the drone 200 and docking station 220.

In one non-limiting embodiment, docking station 220 includes at least one actuator 228 and at least one retainer 230. The at least one actuator 228 may be coupled to the at least one retainer 230 to transition the retainer 230 between a locked position (e.g., when drone 200 is in home position as shown in FIGS. 6A-6B) and an unlocked position (e.g., as shown in FIGS. 7A-7B). In the locked position, the at least one retainer 230 engages or covers a portion of drone 200 to secure drone 200 to docking station 220 when drone 200 is in the home position. The locked position may be used when drone 200 is not in use and/or when vehicle 10 is in motion to secure drone 200 to vehicle 10 to prevent damage and/or accidental disengagement of drone 200 from vehicle 10. In the unlocked position, as shown in FIGS. 7A-7B, actuator 228 is configured to move the at least one retainer 230 such that the at least one retainer 230 no longer engages or covers drone 200. In the unlocked position, drone 200 can release from and take-off from docking station 220. Actuator 228 may include, but is not limited to an electric motor, a stepper motor, or a linear motor. In some embodiments, the at least one retainer 230 is a pair of retainers 230 that are arranged on opposite sides of base 222 to engage opposite sides of drone 200. The retainers 230 may a plastic material, a metal material, or a combination thereof that is configured to engage drone 200 without damage. In some embodiments, as shown in FIG. 6A, actuator 228 is also coupled to cover 226 such that the cover 226 can be removed automatically.

FIGS. 7A and 7B are illustrative embodiments of drone 200 releasing from docking station 220. FIG. 7A illustrates the at least one retainer 230 moved to the unlocked position. In the unlocked position, the at least one retainer 230 no longer covers or engages a portion of drone 200. Drone 200 is then no longer secured to docking station 220 and drone 200 is able to disengage. When disengaged, as shown in FIG. 7B, drone 200 can release from vehicle 10, take-off, and fly away from vehicle 10 via propulsion system 206.

In some embodiments, as shown in FIG. 7B, docking station 220 may be configured to charge drone 200 when the drone 200 is in the home position. Docking station 220 may include charger 224. Charger 224 may include a first connector 234 (e.g., a socket) and a second connector 236 (e.g., a plug). Docking station 220 may include the first connector 234 and drone 200 may include second connector 236, which are configured to contact and engage each other, or cooperate with each other, to charge drone 200 when drone 200 is in the home position. In other embodiments, docking station 220 may be configured for wireless charging which may include, but is not limited to, magnetic charging or inductive charging, such that drone 200 receives power via wireless charging when drone 200 is in the home position. In some embodiments, second connector 236 may be manually plugged into first connector 234 by an operator. In other embodiments, drone 200 may land on docking station 220 such that second connector 236 is lined up with first connector 234 and engages automatically. In some embodiments, magnets or other couplers may facilitate the automatic engagement of second connector 236 and first connector 234.

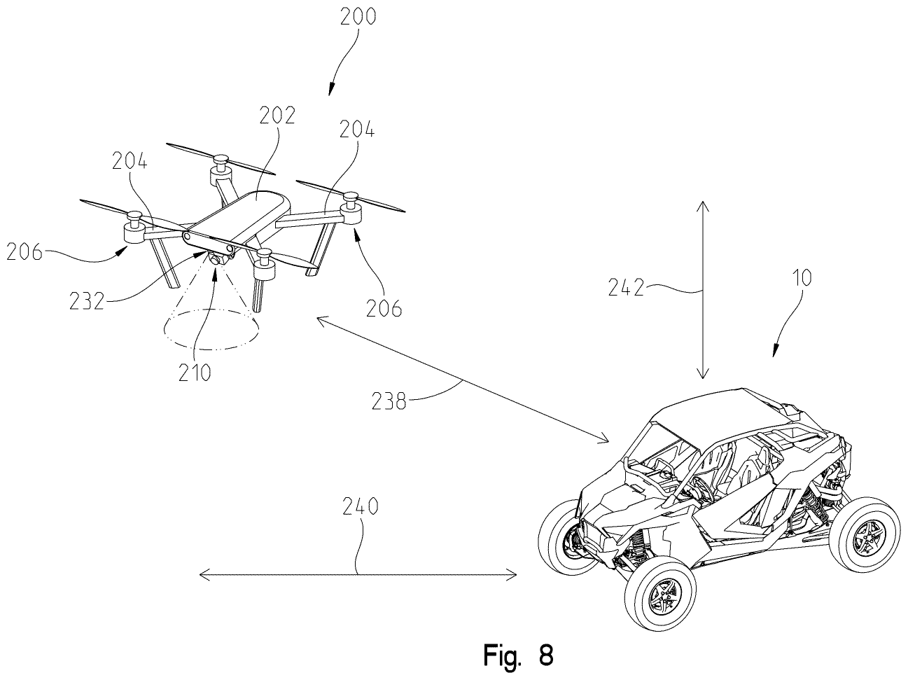

FIG. 8 is an illustrative embodiment of drone 200 tracking vehicle 10. Drone 200 may be configured to follow predetermined path 238 upon release from docking station 220. Predetermined path 238 may be at a predetermined distance relative to vehicle 10. Predetermined path 238 may be at predetermined horizontal length 240 from vehicle 10, predetermined vertical height 242 from vehicle 10, or a combination thereof. In some embodiments, drone 200 may be configured to scout or scope a trail terrain ahead of, to a side of, and/or behind vehicle 10. For example, drone 200 may fly at least one mile, ahead of or behind vehicle 10 as determined by the operator, or at a distance at which the operator maintains a visual line of sight with drone 200. The distance of drone 200 relative to vehicle 10 may conform to limitations set by the Federal Aviation Administration (FAA). Drone 200 may capture pictures or video along its predetermined path 238 via camera or video recorder 210. The captured pictures or video may be transmitted from drone 200 to operator panel 106 such that the operator can view the pictures or video on the display 108 and see trail conditions ahead of, above, and/or behind vehicle 10. In some embodiments, drone 200 may provide a live-broadcast video to operator panel 106. In another example, drone 200 may fly substantially vertically up to approximately 400 feet above vehicle 10. The height of drone's 200 flight relative to vehicle 10 may change to conform to limitations set by the FAA. This may allow the operator to get an arial view of the trial and the area surrounding vehicle 10. Additionally, drone 200 can be configured to illuminate at least a portion of predetermined path 238 via light 232. This may increase visibility for the operator of vehicle 10, especially if the trail is dark.

Predetermined path 238 may be selected using operator panel 106 or a wireless communication device (e.g., a cell phone). Instructions on predetermined path 238 may be sent to drone 200 via controller 112 associated with the vehicle. Drone 200 may then receive the instructions via controller 212 associated with drone 200. In embodiments, the predetermined path 238 is relative to vehicle 10 and as vehicle 10 moves relative to the ground, drone 200 updates its positions to maintain a predetermined path 238 relative to vehicle 10.

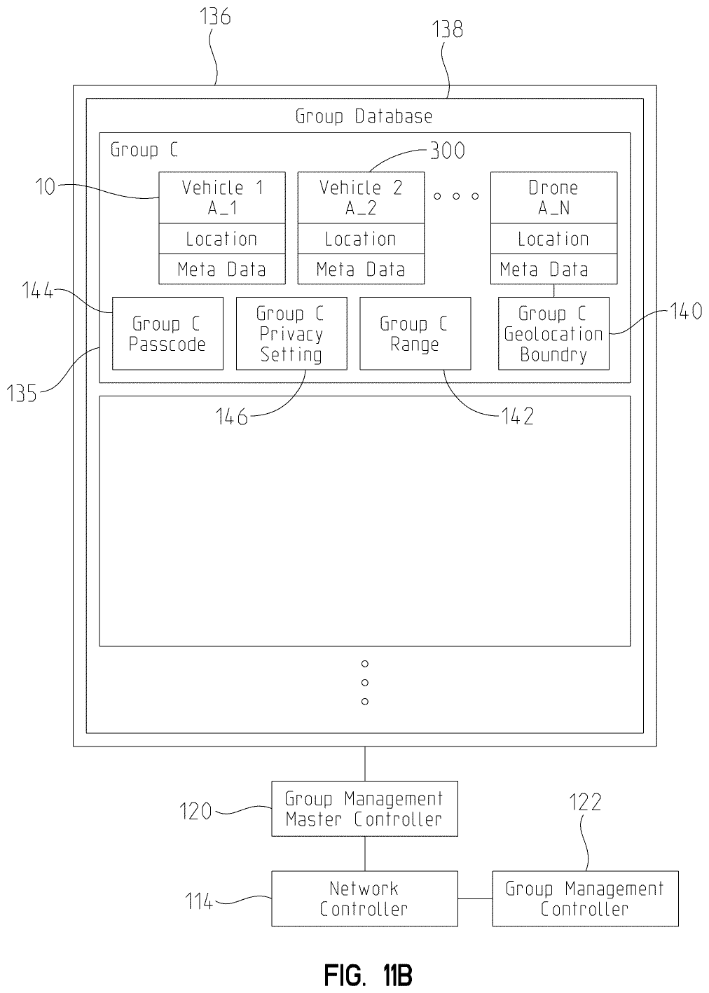

Controllers 112 associated with vehicle 10 further includes a network controller 114 which controls communications between vehicle 10 and other devices (e.g., drone 200) through one or more network components 116. In one embodiment, network controller 114 of vehicle 10 communicates with paired devices over a wireless network. An exemplary wireless network is a radio frequency network utilizing a BLUETOOTH, cellular, or Wi-Fi protocol. In this example, network components 116 includes a radio frequency antenna. Network controller 114 controls the pairing of devices to vehicle 10 and/or the communications between vehicle 10 and another remote device. An exemplary remote device is drone 200 described herein. In one embodiment, network controller 114 of recreational vehicle 10 communicates with a group management master controller 120 over a cellular network. In this example, network components 116 includes a cellular antenna and network controller 114 receives and sends cellular messages from and to the cellular network. In embodiments, group management master controller 120 is part of one of controller 112, 212. In one embodiment, network controller 114 of recreational vehicle 100 communicates with group management master controller 120 over a satellite network. In this example, network components 116 includes a satellite antenna and network controller 114 receives and sends messages from and to the satellite network. Controller 112 associated with vehicle 10 further includes a location determiner 118 which determines a current location of vehicle 10. An exemplary location determiner 118 is a GPS unit which determines the position of recreational vehicle 100 based on interaction with a global satellite system. As discussed in more detail herein, and as illustrated in FIG. 11A-B, a group management controller 122 (part of controller 112 when group management master controller is not part of vehicle 10) controls communicating location updates with group management master controller 120. In some embodiments, group management controller 122 is part of vehicle 10 and may be supported by at least one of frame assembly 20 or plurality of ground engaging members. In one embodiment, one or more of network controller 114, location determiner 118, and group management controller 122 are part of operator panel 106. Controller 212 associated with drone 200 may be configured similarly to controller 112 associated with vehicle 10. Controller 212 associated with drone 200 may be adapted to communicate with vehicle 10 as facilitated by network controller and/or group management master controller 120 as described above. Operator panel 106 and/or controller 112 associated with vehicle 10 may be configured to receive information from drone 200 and drone 200 may be configured to receive information from operator panel 106 and/or controller 112 associated with vehicle 10. Information may include meta data including, but not limited to, distance away 124, altitude 126, last location update time 128, and/or graphical representative of last location 132 on map 130 (e.g., as shown in FIG. 9A).

In some embodiments, drone 200 may interface with a second vehicle 300. Second vehicle 300 may be configured substantially the same as vehicle 10 as described above. FIG. 9A is an illustrative embodiment of operator panel 106 of vehicle 10. Operator panel 106 includes a display 108, which may include a touch display. Operator panel 106 may further include a plurality of buttons 134 for the operator to interface with. Last location update time 128 and graphical representative of last location 132 on map 130 of vehicle 10, second vehicle 300, and drone 200 may be displayed by operator panel 106. Group management master controller 120 may be operatively coupled to display 108 to display the information. Although FIG. 9A is shown with respect to vehicle 10 and second vehicle 300, more than two vehicles may be included (e.g., any number of vehicles ‘N’). Second vehicle 300 may include a similar operator panel to operator panel 106 such that second vehicle 300 also sees the information displayed.

Exemplary displays and their functionality are disclosed in PCT Patent Application No. PCT/US2014/018638, titled RECREATIONAL VEHICLE INTERACTIVE, TELEMETRY, MAPPING, AND TRIP PLANNING SYSTEM, filed Feb. 26, 2014, the disclosure of which is expressly incorporated by reference. Exemplary group management controllers and their functionality are disclosed in PCT Patent Application No. PCT/US2017/017122, titled “RECREATIONAL VEHICLE GROUP MANAGEMENT SYSTEM”, filed Feb. 10, 2016, the disclosure of which is expressly incorporated by reference.

Referring to FIG. 9B, in some embodiments, operator panel 106 may be used to control drone 200 in addition to, or as an alternative to, controller 112. As mentioned herein, in some embodiments, operator panel 106 includes controller 112. FIG. 9B illustrates an exemplary menu screen 150 for controlling drone 200. As shown, menu screen 150 may be one of an overlay, pop-up menu, additional screen/mode, or the like for the embodiment shown in FIG. 9A. For example, menu screen 150 may be accessible by selecting one of the plurality of buttons 134 or, in the case of a touch screen, through one or more gestures, such as a swipe down from a top edge with a finger of an operator.

Menu screen 150 may include a graphical user interface 152 having a plurality of buttons 154 for a user to interact with. The plurality of buttons 154 may include, but is not limited to, a first button 156, a second button 158, a third button 160, and/or a fourth button 162 corresponding to different commands for drone 200. One or more of plurality of buttons 154 may include commands that instruct drone 200 to move relative to vehicle 10. In some embodiments, menu screen 150 may have a directional pad style control, one or more sliders, or other suitable inputs to control one or both of a direction and speed of drone 200.

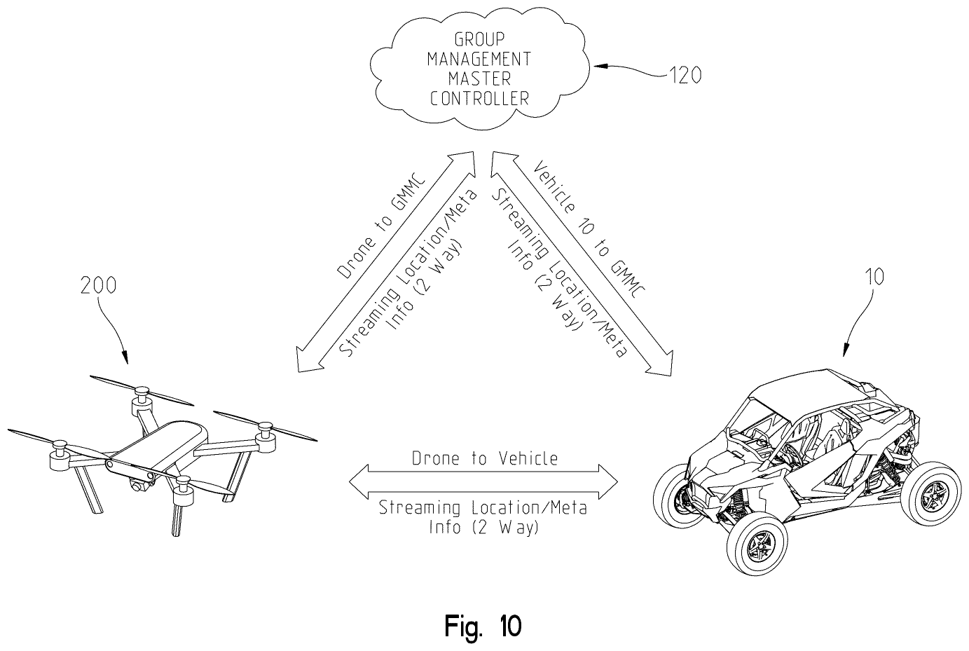

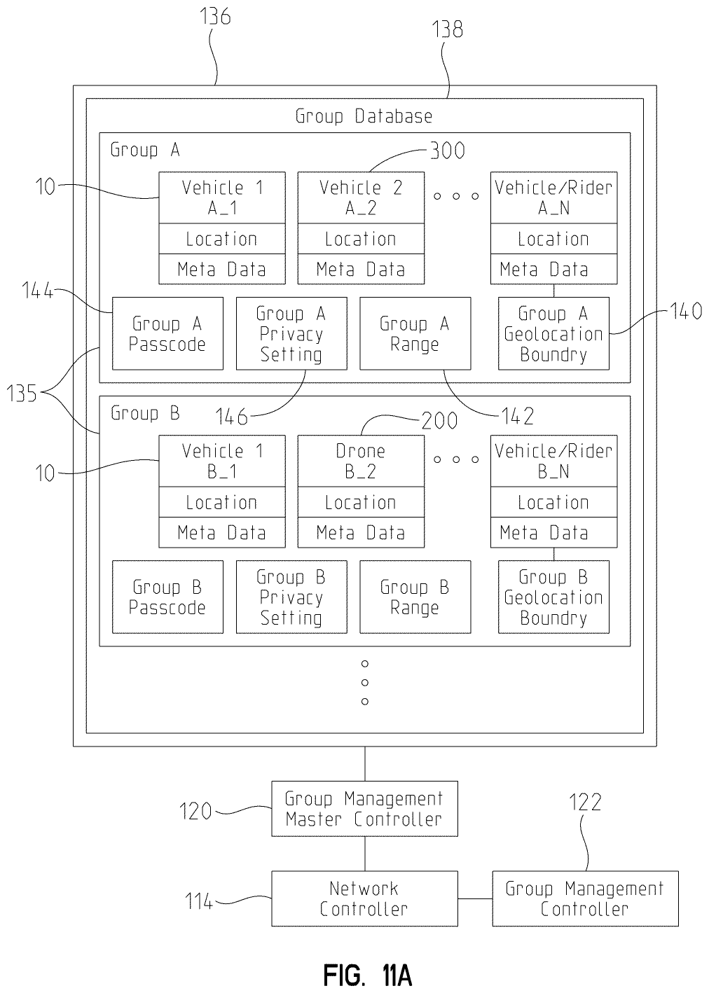

In some examples, first button 156 may be configured to turn camera or video recorder 210 on and/or off to view collected images or live video. Second button 158 may be configured to allow the operator to select and/or modify a path (e.g., path 238) of drone 200. In some embodiments, second button 158 may allow drone 200 to scout or scope a trail terrain ahead of, to a side of, and/or behind vehicle 10, or scout or scope for another vehicle within the group. Group may include Vehicle 1 or Vehicle 2 of FIG. 9A, or others as discussed with respect to FIG. 10. In other embodiments, second button 158 may allow drone 200 to follow vehicle 10, or follow another vehicle within the group. Third button 160 may be configured to control the release of drone 200 from docking station 200 and/or docking of drone 200 onto docking station 220. Fourth button may be configured to control light 232 to illuminate at least a portion of the path.

Referring to FIG. 10, information flow between vehicle 10, drone 200, and group management master controller 120 is illustrated. Controllers 112, 212 of respective vehicle 10 and drone 200 communicate with group management master controller 120 over a wireless network. Exemplary wireless networks include radio frequency networks, cellular networks, and/or satellite networks. Information may flow two-ways such that information flows to the group management master controller 120 from vehicle 10 and vice versa. Similarly, information may flow two-ways such that information flows to the group management master controller 120 from drone 200 and vice versa. Information may also flow two-ways between drone 200 and vehicle 10. Through not shown in FIG. 10, second vehicle 300 may also be included in the information flow with the group management master controller 120 similar to vehicle 10.

Referring to FIGS. 11A and 11B, group management controller 122 controls communicating location updates with group management master controller 120. Group management master controller 120 controls the formation and management of user groups. Group management master controller 120 has access to memory 136 which includes group database 138. In the illustrated example of group database 138, a plurality of groups 135, are shown (e.g., “Group A” and “Group B”). Within user groups, the location of each individual member of the user group may be visible and displayed to each operator (e.g., as shown and described with respect to FIG. 9A). In this way, rider(s) in vehicle 10 and rider(s) in second vehicle 300 may know each other's location when riding together. In one example, as shown in FIG. 11A, vehicle 10 and second vehicle 300 may form a first user group “Group A” such that vehicle 10 and second vehicle 300 can view each other's information. Drone 200 may be excluded from the first user group. A second user group, “Group B”, may be formed between vehicle 10 and drone 200 such that vehicle 10 and drone 200 can view each other's information. Drone 200 may then be associated only with vehicle 10 and shared images and/or video with vehicle 10 and not second vehicle 300. In this way, vehicle 10 may be able to see both drone 200 and second vehicle 300 but drone 200 and second vehicle 300 cannot see each other. In other examples, as shown in FIG. 11B, vehicle 10, drone 200, and second vehicle 300 may all form a single user group “Group C” such that each of vehicle 10, drone 200, and second vehicle 300 share information. In some examples, drone 200 may be excluded from the user groups entirely.

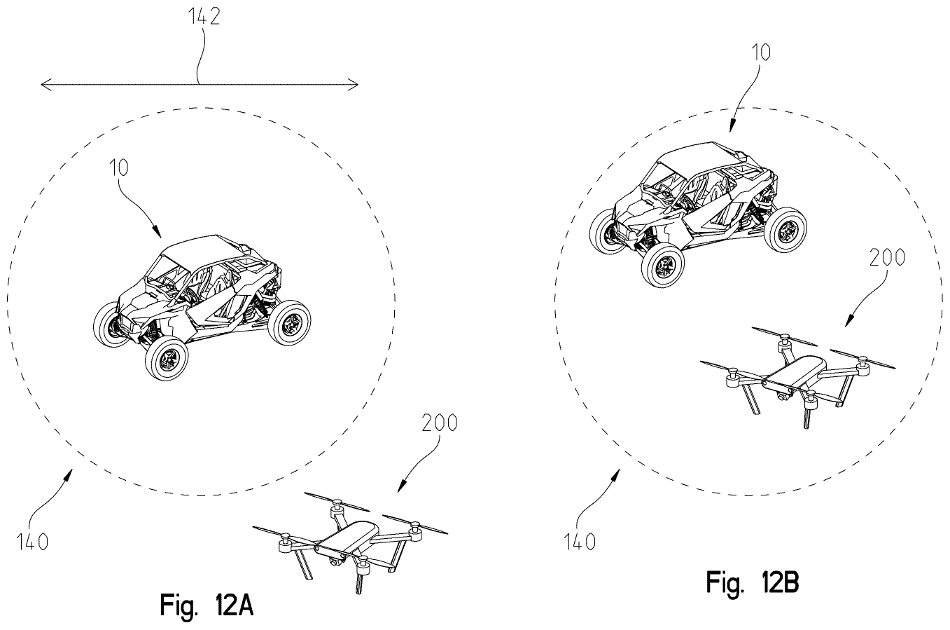

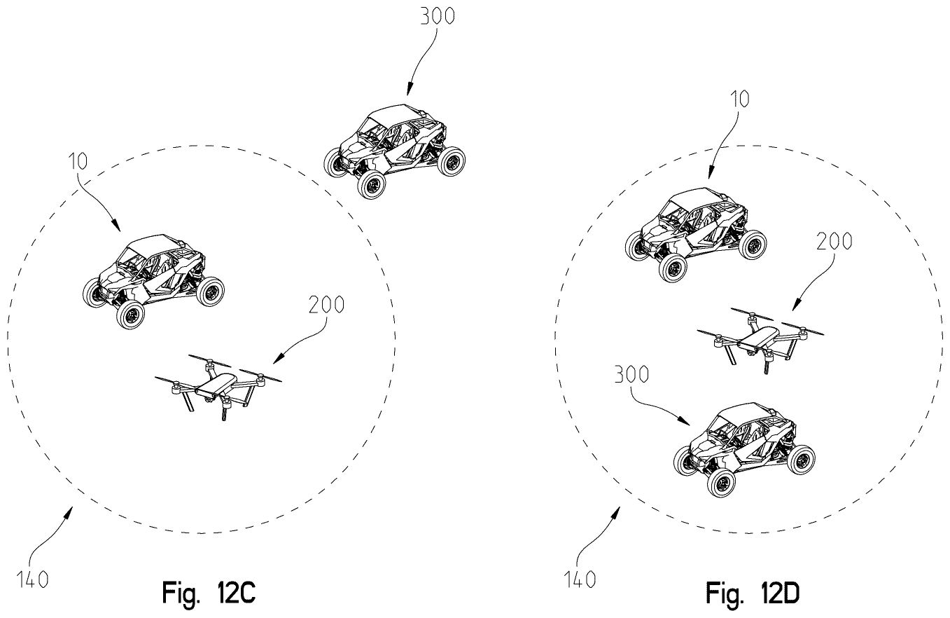

Referring to FIGS. 12A-12D, in some embodiments, another vehicle (e.g., second vehicle 300) or drone 200 may join the user group if they are located within a geolocation boundary 140 associated with the user group. The geolocation boundary 140 is set based on the location of the group members in the user group as defined by the group management master controller 120 (e.g., as shown in FIGS. 11A-11B). The range 142 of geolocation boundary 140 may also be defined by the group management master controller 120. The group may also have privacy setting 144 and/or passcode 146 to prevent unknown riders from joining the group. In FIG. 12A, the group consists of first vehicle 10 (e.g., substantially similar to vehicle 10). In this case, the geolocation boundary 140 is a circle with a radius equal to the value of the range 142. In this scenario, drone 200 as positioned in FIG. 12A could not join the group based on its geolocation because it is outside of geolocation boundary 140. In contrast, if drone 200 is positioned as in FIG. 12B, drone 200 could join the group because its geolocation is within geolocation boundary 140. Similarly in FIG. 12C, second vehicle 300 as positioned in FIG. 12C could not join the group based on its geolocation because it is outside of geolocation boundary 140. In contrast, if second vehicle 300 is positioned as in FIG. 12D, second vehicle 300 could join the group because its geolocation is within geolocation boundary 140. Therefore, in FIG. 12D, the first user group is defined by first vehicle 10, second vehicle 300, and drone 200 when the each of the first vehicle 10, the second vehicle 300, and the drone 200 are positioned within first user group boundary 140 (e.g., as shown in FIG. 12D). The first user group boundary is defined by the group management master controller 120.

As described above, drone 200 is configured to dock on first vehicle 10. When an operator of vehicle 10 wishes to use drone 200, operator may release drone from docking station 220. This may be facilitated by the actuator 228 and retainer 230 configuration as described in FIGS. 6A-7B. Actuator 228 may be in communication with operator panel 106 such that operator can control the release of drone 200 using operator panel 106. Drone 200 may be instructed to follow predetermined path 238 at a predetermined distance relative to vehicle 10. Predetermined distance may be horizontal path 240 relative to vehicle 10, vertical path 242 relative to vehicle 10, or a combination thereof (e.g., predetermined path 238 as shown in FIG. 8). Drone 200 may be further instructed to illuminate at least a portion of a path of vehicle 10 via light 232. First vehicle 10 may then receive, via controller 112 or operator panel 106, at least one of video or images from drone 200, which may then be displayed by operator panel 106 of the vehicle 10. The images or videos may also be received by an intermediate device, such as a cell phone, which may allow the operator of first vehicle 10 to share the images or videos on social media. Drone 200 may also communicate with a second vehicle 300 via controller 212 associated with drone 200. Information or meta data about the second vehicle 300 may be received by drone 200, which may then be shared with vehicle 10. In some embodiments, Drone 200 may be operatively coupled to group management master controller 120 and provide an indication of a position of drone 200 relative to first vehicle 10 to group management master controller 120 and the position of drone 200 may be displayed on the display 108. In one embodiment, information or meta data about the second vehicle 300, such as position of second vehicle 300 may be displayed on display 108 of operator panel 108 of first vehicle 10 (e.g., as shown in FIG. 9A). Similarly, operator panel 106 may include at least one input which alters characteristics of drone 200, which may include, but it not limited to a change in predetermined path 238 where drone 200 may alter its course.

The following clauses are provided as example aspects of the disclosed subject matter:

Clause 1: A vehicle for use with a drone, the vehicle comprising a plurality of ground engaging members; a frame assembly supported by the plurality of ground engaging members; a powertrain operatively coupled to at least one of the plurality of ground engaging members; a docking station supported the frame assembly and adapted to couple to the drone.

Clause 2: The vehicle of clause 1, further comprising an open-air operator area supported by the frame including an operator seat and a passenger seat in a side-by-side relationship.

Clause 3: The vehicle of clause 1, wherein the powertrain further comprises a continuously variable transmission.

Clause 4: The vehicle of claim 1, wherein the docking station in a home position is releasably coupled to the drone, the docking station configured to secure the drone thereto and charge the drone when in the home position, wherein the vehicle is in communication with the drone such that the drone selectively lands on the docking station.

Clause 5: The vehicle of clause 4, wherein the docking station includes a first connector and the drone includes a second connector, the first connector and the second connector cooperating to charge the drone when the drone is in the home position.

Clause 6: The vehicle of clause 4, wherein the docking station includes an inductive charger and the drone receives power from the inductive charger when in the home position.

Clause 7: The vehicle of clause 4, wherein the docking station includes at least one actuator and at least one retainer coupled to the actuator, the at least one retainer engaging a portion of the drone in a locked position to secure the drone to the docking station in the home position.

Clause 8: The vehicle of clause 7, wherein the actuator is configured to move the at least one retainer to the unlocked position to release the drone from the docking station.

Clause 9: The vehicle of clause 4, wherein the drone is operable to follow a predetermined path upon release from the docking station, the predetermined path being at a predetermined distance relative to the vehicle.

Clause 10: The vehicle of clause 9, wherein the drone further comprises a light and the drone is configured to illuminate a predetermined portion of a path of the vehicle with the light.

Clause 11: The vehicle of clause 1, further comprising a plurality of body panels supported by the frame assembly, wherein the plurality of body panels includes a hood and the docking station is positioned on the hood.

Clause 12: The vehicle of clause 1, further comprising an operator panel supported by the frame, the operator panel including a display, the operator panel displaying information collected by the drone.

Clause 13: The vehicle of clause 12, wherein the operator panel includes at least one input which alters a characteristic of the drone.

Clause 14: The vehicle of clause 13, wherein the characteristic of the drone is a change in the predetermined path.

Clause 15: A system comprising a first vehicle comprising a plurality of ground engaging members; a frame assembly supported by the plurality of ground engaging members; a powertrain operatively coupled to at least one of the plurality of ground engaging members; a docking station supported by the frame assembly; and an operator panel including a display; a group management master controller operatively coupled to the display of the operator panel; and at least one drone operatively coupled to the group management master controller, the at least one drone providing an indication of a position of the drone relative to the first vehicle to the group management master controller, the position of the drone being displayed on the display of the operator panel, the at least one drone configured to selectively dock onto the docking station of the first vehicle.

Clause 16: The system of clause 15, wherein the docking station is configured to charge the drone when the drone is coupled thereto.

Clause 17: The system of clause 15, wherein the display further displays at least one of video and images captured by a camera of the drone.

Clause 18: The system of clause 15, further comprising a second vehicle operatively coupled to the group management master controller, a position of the second vehicle being displayed on the display of the operator panel of the first vehicle.

Clause 19: The system of clause 15, wherein the group management master controller is supported by the plurality of ground engaging members of the first vehicle.

Clause 20: A method of facilitating usage of a drone with a vehicle, the vehicle including a plurality of ground engaging members, a frame assembly supported by the plurality of ground engaging members, at least one controller supported by the frame wherein the drone is operatively coupled to the controller, and an operator panel supported by the frame, the method comprising releasing the drone from a docking station, the docking station being supported by the frame of the vehicle and configured to charge the drone; instructing the drone to follow to a predetermined path, the predetermined path being at a predetermined distance relative to the vehicle; and receiving, via the controller, at least one of video or images from the drone, the at least one of video or images being displayed by the operator panel of the vehicle.

Clause 21: The method of clause 20, further comprising instructing the drone to illuminate a at least a portion of a path of the vehicle.

Clause 22: A method of manually controlling usage of a drone with a vehicle, the vehicle including a plurality of ground engaging members, a frame assembly supported by the plurality of ground engaging members, and an operator panel supported by the frame, the method comprising instructing the drone to move relative to the vehicle using one or more inputs of the operator panel of the vehicle; receiving, via a controller of the vehicle, at least one of video or images from the drone; and displaying with the operator panel of the vehicle the at least one of video or images.

Clause 23: The method of clause 22, further comprising the step of coupling the drone to a docking station, the docking station being supported by the frame of the vehicle.

Clause 24: The method of clause 23, further comprising the step of charging the drone while coupled to the docking station.

Clause 25: The method of clause 22, wherein the operator panel includes a graphical user interface and at least one of the one or more inputs of the operator panel are part of the graphical user interface.

Clause 26: The method of clause 22, wherein at least one of a direction and a speed of the drone is controlled through the one or more inputs of the operator panel.

Clause 27: The method of clause 22, further comprising instructing the drone to follow the vehicle.

Clause 28: The method of clause 22, further comprising instructing the drove to scout a path for the vehicle.

Clause 29: The method of clause 22, further comprising instructing the drone to illuminate at least a portion of a path of the vehicle.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A vehicle for use with a drone, the vehicle comprising:
a plurality of ground engaging members;
a frame assembly supported by the plurality of ground engaging members;
a powertrain operatively coupled to at least one of the plurality of ground engaging members;
a docking station supported the frame assembly and adapted to couple to the drone.

2. The vehicle of claim 1, further comprising an open-air operator area supported by the frame including an operator seat and a passenger seat in a side-by-side relationship.

3. The vehicle of claim 1, wherein the powertrain further comprises a continuously variable transmission.

4. The vehicle of claim 1, wherein the docking station in a home position is releasably coupled to the drone, the docking station configured to secure the drone thereto and charge the drone when in the home position, wherein the vehicle is in communication with the drone such that the drone selectively lands on the docking station.

5. The vehicle of claim 4, wherein the docking station includes a first connector and the drone includes a second connector, the first connector and the second connector cooperating to charge the drone when the drone is in the home position.

6. The vehicle of claim 4, wherein the docking station includes an inductive charger and the drone receives power from the inductive charger when in the home position.

7. The vehicle of claim 4, wherein the docking station includes at least one actuator and at least one retainer coupled to the actuator, the at least one retainer engaging a portion of the drone in a locked position to secure the drone to the docking station in the home position.

8. The vehicle of claim 7, wherein the actuator is configured to move the at least one retainer to the unlocked position to release the drone from the docking station.

9. The vehicle of claim 4, wherein the drone is operable to follow a predetermined path upon release from the docking station, the predetermined path being at a predetermined distance relative to the vehicle.

10. The vehicle of claim 9, wherein the drone further comprises a light and the drone is configured to illuminate a predetermined portion of a path of the vehicle with the light.

11. The vehicle of claim 1, further comprising a plurality of body panels supported by the frame assembly, wherein the plurality of body panels includes a hood and the docking station is positioned on the hood.

12. The vehicle of claim 1, further comprising an operator panel supported by the frame, the operator panel including a display, the operator panel displaying information collected by the drone.

13. The vehicle of claim 12, wherein the operator panel includes at least one input which alters a characteristic of the drone.

14. The vehicle of claim 13, wherein the characteristic of the drone is a change in the predetermined path.

15. A system comprising:
a first vehicle comprising:
a plurality of ground engaging members;
a frame assembly supported by the plurality of ground engaging members;
a powertrain operatively coupled to at least one of the plurality of ground engaging members;
a docking station supported by the frame assembly; and
an operator panel including a display;
a group management master controller operatively coupled to the display of the operator panel;
at least one drone operatively coupled to the group management master controller, the at least one drone providing an indication of a position of the drone relative to the first vehicle to the group management master controller, the position of the drone being displayed on the display of the operator panel, the at least one drone configured to selectively dock onto the docking station of the first vehicle.

16. The system of claim 15, wherein the docking station is configured to charge the drone when the drone is coupled thereto.

17. The system of claim 15, wherein the display further displays at least one of video and images captured by a camera of the drone.

18. The system of claim 15, further comprising a second vehicle operatively coupled to the group management master controller, a position of the second vehicle being displayed on the display of the operator panel of the first vehicle.

19. The system of claim 15, wherein the group management master controller is supported by the plurality of ground engaging members of the first vehicle.

20. A method of facilitating usage of a drone with a vehicle, the vehicle including a plurality of ground engaging members, a frame assembly supported by the plurality of ground engaging members, at least one controller supported by the frame wherein the drone is operatively coupled to the controller, and an operator panel supported by the frame, the method comprising:
releasing the drone from a docking station, the docking station being supported by the frame of the vehicle and configured to charge the drone;
instructing the drone to follow to a predetermined path, the predetermined path being at a predetermined distance relative to the vehicle; and
receiving, via the controller, at least one of video or images from the drone, the at least one of video or images being displayed by the operator panel of the vehicle.

21. The method of claim 20, further comprising instructing the drone to illuminate a at least a portion of a path of the vehicle.

22. A method of manually controlling usage of a drone with a vehicle, the vehicle including a plurality of ground engaging members, a frame assembly supported by the plurality of ground engaging members, and an operator panel supported by the frame, the method comprising:
instructing the drone to move relative to the vehicle using one or more inputs of the operator panel of the vehicle;
receiving, via a controller of the vehicle, at least one of video or images from the drone; and
displaying with the operator panel of the vehicle the at least one of video or images.

23. The method of claim 22, further comprising the step of coupling the drone to a docking station, the docking station being supported by the frame of the vehicle.

24. The method of claim 23, further comprising the step of charging the drone while coupled to the docking station.

25. The method of claim 22, wherein the operator panel includes a graphical user interface and at least one of the one or more inputs of the operator panel are part of the graphical user interface.

26. The method of claim 22, wherein at least one of a direction and a speed of the drone is controlled through the one or more inputs of the operator panel.

27. The method of claim 22, further comprising instructing the drone to follow the vehicle.

28. The method of claim 22, further comprising instructing the drove to scout a path for the vehicle.

29. The method of claim 22, further comprising instructing the drone to illuminate at least a portion of a path of the vehicle.
